(19) United States
(12) Patent Application Publication
(10) Pub. No.: US 2018/0159922 A1
(43) Pub. Date: Jun. 7, 2018

(54) JOB ASSIGNMENT USING ARTIFICIALLY DELAYED RESPONSES IN LOAD-BALANCED GROUPS

(71) Applicant: International Business Machines Corporation, Armonk, NY (US)

(72) Inventors: Kanak B. Agarwal, Austin, TX (US); Wenzhi Cui, Austin, TX (US); Wesley M. Felter, Austin, TX (US); Yu Gu, Cedar Park, TX (US); Eric J. Rozner, Austin, TX (US)

(73) Assignee: International Business Machines Corporation, Armonk, NY (US)

(21) Appl. No.: 15/368,776

(22) Filed: Dec. 5, 2016

(51) Int. Cl. H04L 29/08; H04L 29/06; H04L 12/26; H04L 12/24

(52) U.S. Cl. CPC H04L 67/1004; H04L 41/5019; H04L 43/0876; H04L 67/42

(57) ABSTRACT

A detection is made that a first handshake packet has been received from a data processing system at a first system. The first system participates in a load-balanced group managed by a load-balancer. A value is obtained of a metric configured in the first system. from a set of delay functions, a delay function that corresponds to the metric is selected. Using the value of the metric in the selected delay function, a delay period is computed. A transmission of a second handshake packet is delayed for at least the delay period. An intentionally delayed transmission of the second handshake packet is caused after the delay period from the first system to the data processing system.

### TECHNICAL FIELD

The present invention relates generally to a method, system, and computer program product for improving job execution performance in load-balanced groups of peer data processing systems. More particularly, the present invention relates to a method, system, and computer program product for job assignment using artificially delayed responses in load-balanced groups.

### BACKGROUND

In a load-balanced configuration, a load-balancer system receives requests for service from numerous client systems. Depending on the load-balancing algorithm used therein, the load-balancer sends a received request to one of the systems participating in the load-balanced group of systems serviced by the load-balancer. The system that receives the request from the load-balancer processes the request, or queues the request for processing, depending on the conditions and configuration of the system.

Before sending a request to a system in the group, or from time to time, some load-balancers perform active probing of the systems using a handshake process similar to the TCP handshake. For example, a load-balancer sends a request (called a SYN packet) to a subset of the systems in the load-balanced group. In the TCP handshake analogy, the TCP handshake process uses the SYN packet to synchronize the sender's sequence number with the receiver.

A system that receives the SYN packet (the receiving system) sends a packet (called a SYN-ACK or SYN/ACK packet) to the load-balancer. In the TCP handshake analogy, the SYN-ACK packet is request from the receiver to the sender to synchronize the receiver's sequence number and an acknowledgement of the sender's sequence number.

The SYN-ACK packet allows the load-balancer to monitor the health of the receiving system and the receiving system's TCP stack performance. For example, if the network link between the load-balancer and the receiving system is currently congested, the congested link introduces a delay in receiving the SYN at the server or the SYN-ACK packet at the load-balancer, which informs the load-balancer that there is a currently existing issue in using the receiver system for servicing a request and perhaps the request should be sent to another system in the group. Similarly, if the TCP stack of the receiving system is currently exhibiting poor performance, the SYN-ACK packet will consequently be delayed, informing the load-balancer in a similar way.

Conversely, if the SYN-ACK arriving from a particular system in the group is the first to arrive—with the shortest delay due to the current circumstances—the load-balancer concludes that the network link to the particular system is presently healthy, and the particular system is presently able to process requests just as rapidly as the SYN SYN-ACK handshake. Consequently, the load-balancer sends the request to the fastest responding system in the group.

Offloading of a request is the process of diverting a request from one system to another in a load-balanced group of systems. Presently, if a system in a load-balanced group is experiencing a problem, or has excessive utilization of a computing resource such as the processor, the memory, the network bandwidth, the electrical power, or some other computing resource, the system can offload the request to another peer system in the group.

The active probing method employed by some load-balancers allows the load-balancer to consider the SYN-ACK response from the various systems in the group to assign a request. For example, the load-balancing algorithm selects that system for sending the request whose SYN-ACK is received first.

### SUMMARY

The illustrative embodiments provide a method, system, and computer program product. An embodiment includes a method that detects receiving from a data processing system a first handshake packet at a first system, the first system participating in a load-balanced group managed by a load-balancer. The embodiment obtains a value of a metric configured in the first system. The embodiment selects, from a set of delay functions, a delay function that corresponds to the metric. The embodiment computes, using the value of the metric in the selected delay function, a delay period. The embodiment prevents a transmission of a second handshake packet for at least the delay period. The embodiment causes, from the first system to the data processing system, an intentionally delayed transmission of the second handshake packet after the delay period.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for job assignment using artificially delayed responses in load-balanced groups in accordance with an illustrative embodiment;

FIG. 4 depicts a block diagram of an example configuration for job assignment using artificially delayed responses in load-balanced groups in accordance with an illustrative embodiment; and

FIG. 5 depicts a flowchart of an example process for job assignment using artificially delayed responses in load-balanced groups in accordance with an illustrative embodiment.

### DETAILED DESCRIPTION

The illustrative embodiments recognize that there are instances when a participant system of a load-balancing group may not want to take a request for processing. For example, there may exist a current condition at the system, which would not delay the SYN-ACK, but is a reason why the system should not accept a request.

As some non-limiting examples, suppose that the system is processing a high-priority workload, which should proceed as smoothly on the system as possible according to a service level agreement (SLA). The workload might not be utilizing the resources of the system beyond a level when the utilization level begins to slow down SYN-ACK packet transmission from the system. However, it may be desired that the system not process a request while the workload is processing. For example, a second workload/request could make the system process the first workload in a less efficient manner. Such reduction in the efficiency of the first workload may be undesirable for some reason.

The illustrative embodiments recognize that presently a participant system of a load-balancing group cannot indicate such non-delaying present circumstances-related desires to the load-balancer. Even if a participant system theoretically could send this info to a load-balancer, such communication is not scalable, has high overhead, and requires modifications to the load-balancer. Presently, the load-balancer will avoid sending a request to the system if a SYN-ACK from another system arrives at the load-balancer before the SYN-ACK of the system.

The illustrative embodiments recognize that there are other instances when a participant system of a load-balancing group may not want to take a request for processing. For example, a future condition may be planned at the system, which would have no delaying effect on the SYN-ACK at the current time, but is a reason why the system should not presently accept a request.

As some non-limiting examples, suppose that the system is planned to process a high-priority workload in the future, or that the system is planned for undergoing maintenance in the future, for which the system should prepare by emptying the queue and not accepting further requests at the present time. The future plans might not have any delaying effect on the SYN-ACK packet transmission at the present time from the system. A queue is any suitable method of organizing the requests that arrive at a system before the requests are processed by the system.

The illustrative embodiments recognize that presently a participant system of a load-balancing group cannot indicate such desires related to a future or expected condition of the system to the load-balancer. Presently, the load-balancer will avoid sending a request to the system so long as a SYN-ACK from another system arrives at the load-balancer before the SYN-ACK of the system.

The illustrative embodiments recognize that the presently available tools or solutions do not address these needs or provide adequate solutions for these needs. The illustrative embodiments used to describe the invention generally address and solve the above-described problems and other problems related to job assignment using artificially delayed responses in load-balanced groups.

An embodiment can be implemented as a software application. The application implementing an embodiment can be configured as a modification of an existing SYN SYN-ACK transaction handling system in a participant system of a load-balanced group, as a separate application that operates in conjunction with an existing SYN SYN-ACK transaction handling system in the participant system of the load-balanced group, a standalone application, or some combination thereof. While the operations of the various embodiments are described using SYN SYN-ACK transactions, the same operations can be implemented using other request-response packets without departing the scope of the illustrative embodiments. For example, if a load-balancer uses long-lived connections, the load-balancer may broadcast a request (not necessarily a SYN packet) in a manner described herein. The load-balancer may receive responses (not necessarily SYN-ACK packets) from the managed servers in a manner described herein. The load-balancer may then assign a job to the server whose response arrives first at the load-balancer.

For example, an embodiment can be implemented in or with a virtual switch on hypervisor, can be a part of an operating system kernel, can be implemented as a part of a server application, can be implemented in the TCP stack, or some combination thereof. Furthermore, an embodiment operates to provide present or future condition-based deliberate request refusal functionality to a system; and in doing so operates separately and independently of any prior-art algorithm that uses unintentional and consequential SYN-ACK packet delays caused by currently existing packet-delaying conditions in the system and/or the network.

An embodiment executes at a participant system of a load-balanced group. The embodiment detects that a SYN packet, or an equivalent thereof, has been received at the participant system (also referred to herein as the “receiving system”). The embodiment is configured to measure a specific metric of the receiving system, or receive a measurement of the metric.

Some non-limiting examples of the metric include—a highest priority of a workload being currently processed or planned for the future, a restriction currently in effect or planned to be in effect in the future, number of current workloads being processed on the system, a utilization level of a system or network resource currently reached or predicted to be reached in the future, a condition of a system or network resource currently reached or forecasted to be reached in the future, and so on.

A delay function is a computation, or an algorithm for performing a computation, where the input value is a measurement of a metric, and an output value is an amount of time by which a transmission of a SYN-ACK packet should be delayed from the system. Furthermore, it is possible, but not necessary, to have different delay functions correspond to different metrics, different ranges of the measured values of a metric, different combinations of metrics, or some combination thereof.

Additionally, a delay function may be static. For example, the delay function may employ a computation to provide the same output for the same input. Alternatively, a delay function may be dynamic. For example, the delay function may employ a computation that produces different output values for the same input value based on conditions other than the metric. A non-limiting example of a static delay function computes a delay value that is proportional to a measured value of the selected metric. A non-limiting dynamic delay function may enable a server to delay the response based on a previous response to a previous request within some timeframe. This dynamic adjustment may be helpful in the case when the server may expect to receive a lot of workloads because the server set a very small delay value on some previous SYN-ACKs. Accordingly, the server may then start to dynamically increase the delay in future SYN/ACKs based on this anticipation of increased workload.

Given the selected metric and the measured value of the metric, an embodiment selects a suitable delay function from a set of delay functions. The embodiment computes a delay value using the measured value of the metric. The embodiment outputs the computed delay amount to another application or component of the system, causes another application or component of the system to delay a transmission of a SYN-ACK packet, or an equivalent hereof, to the load-balancer, itself delays the transmission of the SYN-ACK packet to the load-balancer, or some combination thereof.

The manner of job assignment using artificially delayed responses in load-balanced groups described herein is unavailable in the presently available methods. A method of an embodiment described herein, when implemented to execute on a device or data processing system, comprises substantial advancement of the functionality of that device or data processing system in enabling a participating system-side control of when to receive or avoid receiving a request from a load-balancer in a load-balanced group.

Furthermore, aspects of the illustrative embodiments are described using SYNs transmitted from a load-balancer and SYN-ACKs transmitted from a participant server only as a non-limiting example. Using a similar principle of operation, a server may offload a request to another server as well. For example, a server may have to choose which other server to use for offloading a request. If a server decides to offload an already assigned request to another server, the server may employ a procedure similar to a load-balancer's active probing. The server, to which the request has been assigned, may transmit SYN or equivalent packets to one or more other servers in the load-balanced group. The other servers may delay their SYN-ACKs or equivalent responses to the SYN-sending server in a manner described herein. Thus, other servers can try to bias the offload decision of the SYN-sending server.

The illustrative embodiments are described with respect to certain types of requests, packets, delay-causing present and future conditions, delay functions, metrics, measurements, delays, algorithms, peer systems, load-balancing, thresholds, tolerances, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

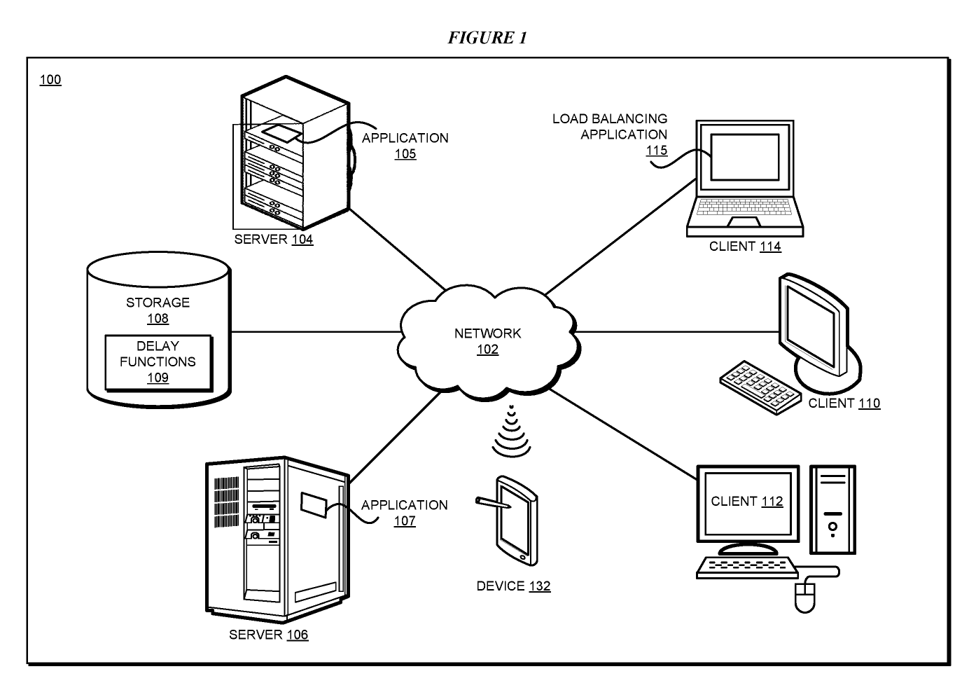

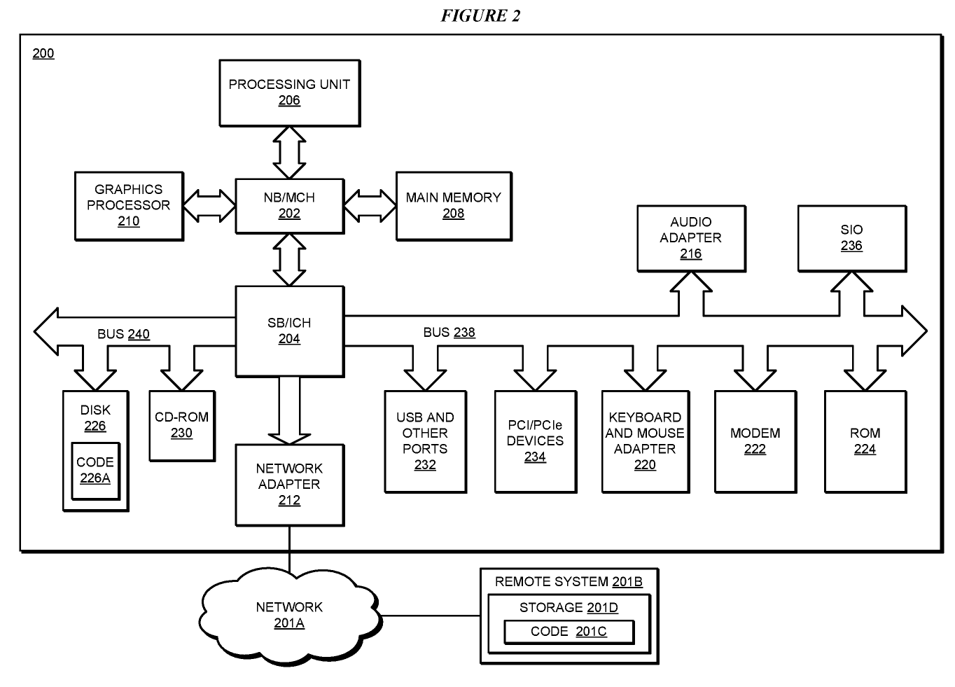

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Assume that servers 104 and 106 are participant systems in a group managed by a load-balancer—a role played by data processing system 114. Application 105 implements an embodiment in participant system 104, and application 107 implements an embodiment in participant system 106, as described herein. Delay functions 109 is a collection of delay functions for use with various measurements of various metrics or various combinations thereof, in repository 108. Load-balancing application 115 in load-balancer 114 sends SYN packets, or an equivalent thereof, to participant systems 104 and 106. Application 105, and/or application 107 cause the SYN-ACK packets, or equivalents thereof, to be delayed according to the selected metrics in their respective systems and the measured values of those metrics. The measured value may be a presently measured value of the metric or a forecasted value of the metric at a future time. As an example operation, application 105 uses a delay function 109 to compute a delay value corresponding to the measured value of the selected metric. Application 105 prevents the transmission of the SYN-ACK packet from participant system 104 until a time period equal to the computed delay value has elapsed. After the expiration of the delay value computed by application 105, application 105 causes the transmission of the SYN-ACK packet from participant system 104 to load-balancer 114. Application 107 operates in a similar manner.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as applications 105 and 107 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

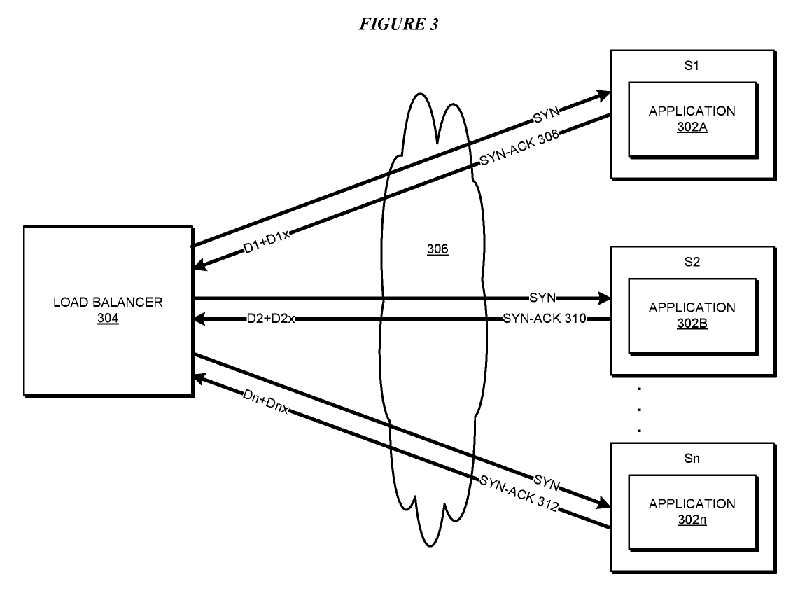

With reference to FIG. 3, this figure depicts a block diagram of an example configuration for job assignment using artificially delayed responses in load-balanced groups in accordance with an illustrative embodiment. Applications 302A, 302B, and 302N are each an example of application 105 or 107 in FIG. 1. Data processing systems S1, S2, . . . Sn are participant systems in a load balanced group manages by load-balancer 304 over data network 306. Application 302A operates in system S1, application 302B operates in system S2, and application 302N operates in server Sn.

Load-balancer 304 sends SYN or equivalent packets to each of S1, S2, . . . Sn, or a subset thereof. Each participant system that receives a SYN or an equivalent packet responds with a SYN-ACK or an equivalent packet.

According to an operation described herein, application 302A in S1 computes an intentional delay of D1x. S1 does not transmit SYN-ACK 308 until D1x has elapsed. Thereafter, S1 transmits SYN-ACK 308 to load-balancer 304. Only for the clarity of the description, assume that SYN-ACK packet 308 of S1 will suffer some unintended delay D1 due to some conditions currently prevailing in system S1, network 306, or both. Thus, SYN-ACK 308 arrives at load-balancer after delay D1+D1x.

Similarly, application 302B in S2 computes an intentional delay of D2x. S2 does not transmit SYN-ACK 310 until D2x has elapsed. Thereafter, S2 transmits SYN-ACK 310 to load-balancer 304. Again, assume that SYN-ACK packet 310 of S2 will suffer some unintended delay D2 due to some conditions currently prevailing in system S2, network 306, or both. Thus, SYN-ACK 310 arrives at load-balancer after delay D2+D2x. By similar reasoning, SYN-ACK 312 of Sn arrives at load-balancer 304 after delay Dn+Dnx.

Thus, each participant system S1 . . . Sn can intentionally delay their respective SYN-ACK packets in order to indicate some present or future value of some metric or combination of metrics to load-balancer 304. From load-balancer 304's point of view, the SYN-ACKs are simply arriving with some total delays, and load-balancer 304 does not know or care whether some part of the total delay is intentional. Operating in this manner, and entirely by a participant system-side functionality, a participant system has successfully influenced the load-balancer's decision to send a request to the system without the load-balancer knowing about the influence, without the load-balancer being modified for such influence.

For example, if only the unintentional delays D1, D2, and Dn were available to load-balancer 304, and if D1 was less than D2 and Dn, load-balancer 304 would send a request to S1. However, if D1+D1x is greater than D2+D2x and Dn+Dnx, load-balancer 304 will send the request to a participant system other than S1. For example, if D2+D2x was smaller than both D1+D1x and Dn+Dnx, then load-balancer 304 would divert or send the request to S2 instead of S1.

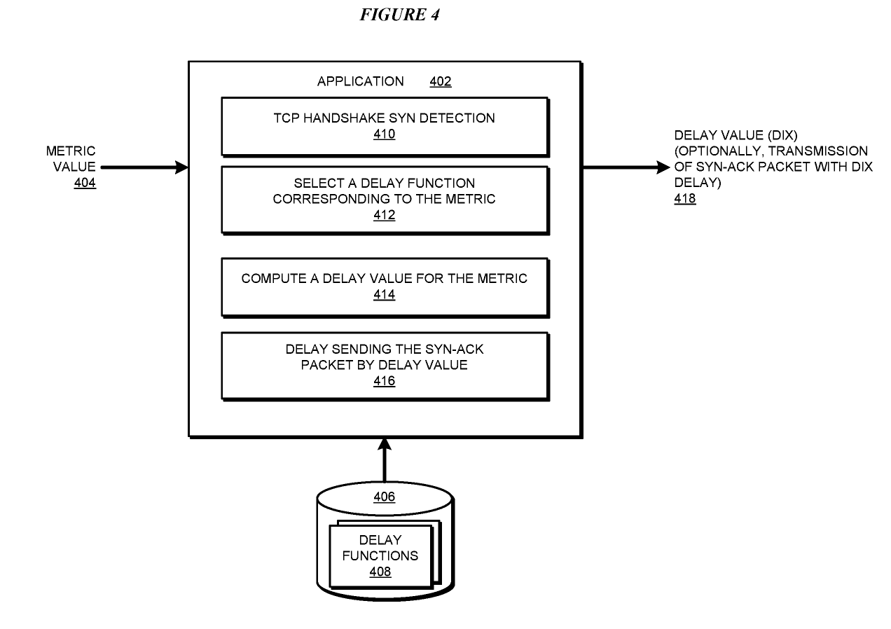

With reference to FIG. 4, this figure depicts a block diagram of an example configuration for job assignment using artificially delayed responses in load-balanced groups in accordance with an illustrative embodiment. Application 402 is an example of any of applications 302A, 302B, or 302n in FIG. 3.

Application 402 receives or measures value 404 of a selected metric of the participant system where application 402 is executing. Repository 406 is an example of repository 108 in FIG. 1, and stores a set of delay functions 408 in the manner of delay functions 109 in FIG. 1.

Component 410 detects or receives a SYN packet, or an equivalent thereof, from a load-balancer, e.g., from load-balancer 304 in FIG. 3. Depending on the selected metric, value 404, or both, component 412 selects a delay function from delay functions 408. Component 414 computes a delay value using the selected delay function and value 404.

Component 416 causes the sending of the SYN-ACK packet, or an equivalent thereof, to be delayed by the computed delay value. For example, application 402 may output delay value 418 to another application which delays the SYN-ACK packet transmission. Alternatively, application 402 itself delays the transmission of the SYN-ACK packet by the delay value, as described herein.

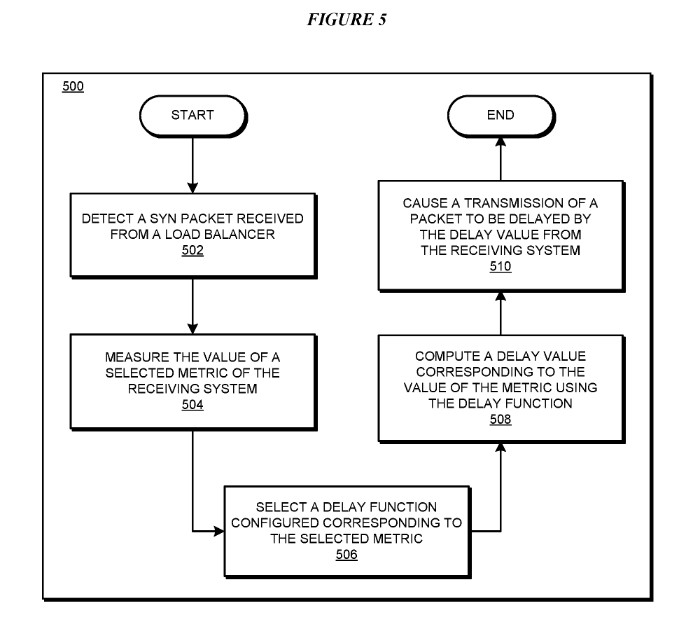

With reference to FIG. 5, this figure depicts a flowchart of an example process for job assignment using artificially delayed responses in load-balanced groups in accordance with an illustrative embodiment. Process 500 can be implemented in application 402 in FIG. 4.

The application detects the reception of a SYN packet from a load-balancer (block 502). The application measures or obtains a value of a selected metric of the receiving system (block 504). The value of the metric can be an actual present value being measured, or a predicted future value expected for the metric at a future time.

The application selects a delay function that is configured to at least correspond to the selected metric (block 506). Using the delay function and the value of the metric, the application computes a delay value (block 508). The application causes a transmission from the receiving system of a SYN-ACK packet to be delayed by the delay value (block 510). The application ends process 500 thereafter.

Thus, a computer implemented method, system or apparatus, and computer program product are provided in the illustrative embodiments for job assignment using artificially delayed responses in load-balanced groups and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
detecting receiving from a data processing system a first handshake packet at a first system, the first system participating in a load-balanced group managed by a load-balancer;
obtaining a value of a metric configured in the first system;
selecting, from a set of delay functions, a delay function that corresponds to the metric;
computing, using the value of the metric in the selected delay function, a delay period;
preventing a transmission of a second handshake packet for at least the delay period; and
causing, from the first system to the data processing system, an intentionally delayed transmission of the second handshake packet after the delay period.

2. The method of claim 1, wherein the delay period is independent of any delay that is a consequence of a delay-causing condition in the first system.

3. The method of claim 1, wherein the delay period is independent of any delay that is a consequence of a delay-causing condition in a data network path between the first system and the load balancer.

4. The method of claim 1, wherein the set of delay functions comprises a different delay function, wherein the different delay function corresponds to a different metric.

5. The method of claim 1, wherein the selected delay function further corresponds to a range of values of the metric, wherein the obtained value of the metric is in the range of values.

6. The method of claim 1, further comprising:
selecting the metric according to a condition prevailing in the first system, wherein the value of the metric is a current value of the metric measured at a present time in the first system.

7. The method of claim 6, wherein the condition prevailing in the first system comprises:
a highest priority of a workload being processed by the first system at the present time.

8. The method of claim 6, wherein the condition prevailing in the first system comprises:
a restriction in effect at the first system at the present time.

9. The method of claim 6, wherein the condition prevailing in the first system comprises:
a utilization level reached by a component of the first system at the present time.

10. The method of claim 1, further comprising:
selecting the metric according to a condition forecasted in the first system, wherein the value of the metric is a predicted value of the metric expected at a future time in the first system.

11. The method of claim 10, wherein the condition forecasted in the first system comprises:
a highest priority of a workload expected to be processed by the first system at the future time.

12. The method of claim 10, wherein the condition forecasted in the first system comprises:
a restriction forecasted to be in effect at the first system at the future time.

13. The method of claim 10, wherein the condition forecasted in the first system comprises:
a utilization level predicted to be reached by a component of the first system at the future time.

14. The method of claim 1, wherein the first handshake packet is a synchronization (SYN) request packet used in Transmission Control Protocol (TCP) handshake procedure, and wherein the second handshake packet is a synchronization-acknowledgement (SYN-ACK) request packet used in the TCP handshake procedure.

15. The method of claim 1, wherein the data processing system is the load-balancer.

16. The method of claim 1, further comprising:
determining, as a part of obtaining the value of the metric, a previous delay period, wherein the metric comprises the previous delay period, the previous delay period having been set by the first system in a previous second handshake packet at a past time; and
computing, as a part of computing the delay period, an adjustment to apply to the previous delay period, the previous delay period and the adjustment together forming the delay period.

17. A computer usable program product comprising one or more computer-readable storage devices, and program instructions stored on at least one of the one or more storage devices, the stored program instructions comprising:
program instructions to detect receiving from a data processing system a first handshake packet at a first system, the first system participating in a load-balanced group managed by a load-balancer;
program instructions to obtain a value of a metric configured in the first system;
program instructions to select, from a set of delay functions, a delay function that corresponds to the metric;
program instructions to compute, using the value of the metric in the selected delay function, a delay period;
program instructions to prevent a transmission of a second handshake packet for at least the delay period; and
program instructions to cause, from the first system to the data processing system, an intentionally delayed transmission of the second handshake packet after the delay period.

18. The computer usable program product of claim 17, wherein the computer usable code is stored in a computer readable storage device in a data processing system, and wherein the computer usable code is transferred over a network from a remote data processing system.

19. The computer usable program product of claim 15, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to detect receiving from a data processing system a first handshake packet at a first system, the first system participating in a load-balanced group managed by a load-balancer;
program instructions to obtain a value of a metric configured in the first system;
program instructions to select, from a set of delay functions, a delay function that corresponds to the metric;
program instructions to compute, using the value of the metric in the selected delay function, a delay period;
program instructions to prevent a transmission of a second handshake packet for at least the delay period; and
program instructions to cause, from the first system to the data processing system, an intentionally delayed transmission of the second handshake packet after the delay period.
